(19) United States
(12) Patent Application Publication
(10) Pub. No.: US 2022/0292406 A1
(43) Pub. Date: Sep. 15, 2022

(54) ANALYZING AND ENABLING SHIFTS IN GROUP DYNAMICS

(71) Applicant: International Business Machines Corporation, Armonk, NY (US)

(72) Inventors: Indervir Singh Banipal, Austin, TX (US); Shikhar Kwatra, San Jose, CA (US); Nadiya Kochura, Bolton, MA (US); Sourav Mazumder, Contra Costa, CA (US)

(21) Appl. No.: 17/199,918

(22) Filed: Mar. 12, 2021

(51) Int. Cl. G06N 20/20

(52) U.S. Cl. CPC G06N 20/20; G10L 17/22

(57) ABSTRACT

Analyzing and enabling shifts in group dynamics by receiving data regarding interactions of a plurality of participants, determining an interaction context according to the data, determining interaction dynamics according to the interaction context using a first machine learning model, determining an interaction trend between a first participant and a second participant, according to the interaction dynamics, using a second machine learning model, detecting a bias between the first participant and the second participant according to the interaction trend, generating a remediation action to shift the interaction dynamics and providing the remediation action to at least one participant.

### BACKGROUND

The disclosure relates generally to analyzing and enabling shifts in group dynamics. The disclosure relates particularly to identifying interaction bias and generating remediating actions for group interactions.

During group interactions such as group meetings, there can be incidents where all attendees do not participate equally. In some instances, this is due to a single attendee having expert knowledge of a topic and communicating that knowledge to the other attendees. In some instances, it is due to a small group discussing the topic while others simply listen in interest. Unequal participation may also arise when one, or a few, of the participants actively prevent others from participating in the discussion. In some instance each attendee participates equally in the discussion, or at least as much as they desire.

In group interactions, participants may be denied any opportunity to contribute to the discussion. Attendees may be discouraged and refrain from participating due to the groups' dynamics. Individuals may begin to contribute to a discussion only to be ignored, or ridiculed, causing them to cease attempts to participate, and discouraging others from beginning to participate. Such group interactions may yield opinions without participation from all members, and in some instances, without participation from a majority of participants. Such interactions may reach a false consensus where a group decision is reached but without the true or actual support of the participants, leading to failed actions as members leave the discussion and don't support the decision. In some instances members actively undermine decisions reached with a false consensus. In some instance, personality traits of one participant overwhelm the group, inhibiting other members of the group and reducing the overall level of participation.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable participation analysis and remediation for group interactions.

Aspects of the invention disclose methods, systems and computer readable media associated with analyzing and enabling shifts in group dynamics by receiving data regarding interactions of a plurality of participants, determining an interaction context according to the data, determining interaction dynamics according to the interaction context using a first machine learning model, determining an interaction trend between a first participant and a second participant, according to the interaction dynamics, using a second machine learning model, detecting a bias between the first participant and the second participant according to the interaction trend, generating a remediation action to shift the interaction dynamics and providing the remediation action to at least one participant.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

In an embodiment, one or more components of the system can employ hardware and/or software to solve problems that are highly technical in nature (e.g., receiving data regarding interactions of a plurality of participants, determining an interaction context according to the data, determining interaction dynamics according to the interaction context using a first machine learning model, determining an interaction trend between a first participant and a second participant, according to the interaction dynamics, using a second machine learning model, detecting a bias between the first participant and the second participant according to the interaction trend, generating a remediation action to shift the interaction dynamics, providing the remediation action to at least one participant, etc.). These solutions are not abstract and cannot be performed as a set of mental acts by a human due to the processing capabilities needed to facilitate participation analysis and remediation for group interactions, for example. Further, some of the processes performed may be performed by a specialized computer for carrying out defined tasks related to analysis and enablement of shifts in group dynamics. For example, a specialized computer can be employed to carry out tasks related to analyzing group interactions and enabling shifts in the group's dynamics, or the like.

Fostering a culture of inclusive meetings is emerging as a competitive advantage. Building that culture requires understanding the biases that sabotage team effectiveness and providing suggestions to reduce or eliminate the effects of those biases in team interactions. The absence of complete engagement and participation by all members of a group in an interaction may yield sub-optimal results for the group. When all members either choose not to participate due to group dynamic impediments, or are prevented from participating, all viewpoints aren't heard, all ideas are not presented and the potential for high performance from an inclusive dynamic is reduced. Disclosed embodiments enable raising the potential for a more inclusive, high performing team dynamic by analyzing the interactions of group members, and then identifying inclusiveness and performance reducing biases in these interactions. Embodiments then generate suggested actions to enable altering the group interaction dynamics toward a more inclusive and higher performing state. The application of disclosed embodiments to virtual meetings and non-virtual meeting, with human moderators as well as artificial intelligence-based moderators, yields a more inclusive and higher performing group dynamic.

In some interactions, such as an interaction where a single expert presents to a group on a topic of interest and/or importance to the group, a lack of group participation is not an indicator of failed collaboration. In such interactions, the lack of additional speakers may indicate group engagement with the presenter and a positive group dynamic which requires no adjustment. Such a situation may be identified by the absence of cues indicating that group members feel excluded from the discussion or otherwise cut off from participating in the discussion. The absence of such cues in the interaction analysis indicates a healthy group dynamic in spite of how much of the group's time a single speaker uses.

In an embodiment, the method receives interaction data for a group of participants. The interaction data may be historic, such as video data from a meeting which occurred prior to the analysis, or the interaction data may be provided in real-time for a contemporaneous group interaction. In this embodiment, the method has previously received visual and audible data for each participant of the plurality of participants of the group. Each participant opts-in to the use of the method and consents to providing audio and video data about themselves for use by the method of the embodiment. In an embodiment, the method anonymizes any identifying audio or video data associated with any participant prior to pushing such data to edge cloud or cloud resources for processing.

In this embodiment, the method analyzes the interaction data according to the provided participant audio and video identifying data, to determine which participant is speaking, how long each participant speaks as well as the reaction of other participants to each speaker and to any interruptions while they are speaking. In this embodiment, the method determines a meeting or interaction context according to the content and tone of individual speeches, as well as the pattern of speech interactions between the respective group participants. In this embodiment, the method analyzes facial cues of participants as well as voice tones of the individual speakers to determine reactions.

Context relates to participation expectations for each group member. In case of a department meeting where a senior person is addressing the group, it would be expected that the participation would be biased towards that speaker or towards the meeting chair. In this context, it is not an indication of abnormal behavior or bias between group members if the speaker/chair speaks most of the time and the method won't count it as the speaker speaking out of the normal patterns because the context expects the speaker to speak more.

As another example, if the meeting is a generic meeting and everyone is expected to speak, the context has an expectation of more equal participation, rather than of only listening as in the first case. In this case the disclosed methods would definitely count one person dominating the conversation as out of normal and will be noted down for further analysis.

In an embodiment, the method utilizes Mel-Frequency Cepstral Coefficients (MFCC) with Gaussian Mix Models, to identify each speaker after spectrogram analysis of 15-D speech data with consideration for the audio data provided with consent, from each participant.

The method tracks the speaking patterns of the participants, who is speaking, how much is each participant speaking, patterns of speaker order—who speaks after each participant finishes speaking, etc. For each participant, the method iterates a Markov-chain model of the speeches of each participant and the speech groupings of pairs of participants, and stores the model in a dictionary format appended to the meeting and in a private repository associated with each participant within the dictionary.

In this embodiment, the method determines a baseline of speech patterns for each participant, how much each participant speaks and for how long, patterns in speaker order—e.g., does a participant P1 always follow a specific speaker P2, such as by interrupting the previous speaker P2. In this embodiment, the method compares current data for each participant with the baseline for that participant to identify normal and abnormal interactions; e.g., participant P1 typically has a relatively low level of participation, therefore their current relatively low level of participation for P1 is normal and not an outlier.

In determining the baseline for each speaker, the method may also consider the personality traits of each speaker. The method determines the personality traits from data associated with past interactions including the participant. In an embodiment, the method utilizes the Big 5 Personality Model, or similar models, to associate personality traits with participants according to the interaction data including the participant. The method includes the frequency of each participant's contributions as well as the participant's aggression level during the interactions—determined according using a tone analyzer. The method also considers the number of sentences or utterances recognized as contributed by each participant in total and as a fraction of the number of sentences and utterances recognized and contributed by the group of participants, as well as the tone of each sentence or utterance of each participant. In an embodiment, the method updates and adjusts the stored baselines for participants according to new interaction data received associated each participant's interactions.

In an embodiment, the method uses the personality traits, number and duration of speeches, speech tone—including aggression levels according to tone, and participant baselines, to analyze the interactions between pairs of participants, such as the pair P1, and P2. In this embodiment, the method utilizes a machine learning model, such as a reinforcement learning model, to analyze the interaction data according to the determined context to determine and classify the dynamics between pairs of participants. In this embodiment, the method utilizes the most updated version of the baseline for each participant.

For example, the method differentiates between a meeting having the context of a group discussion and a townhall. In the method expects most participants to engage and participate, in the second only the department chair is expected to speak. The method notes the following cues for each person: tone of the voice; percentage of the participation; aggression levels etc. through facial analysis; and all other visual recognition based, audio/tone based, speech aggression based signals, etc., which can be acquired.

In the example, the method generates a vector of features for each participant using these values. The method compares the generated vector against the baseline vector for a participant (where baseline vector means the average of the user's personality until now) The baseline indicates the personality and/or normal/usual participation level of the participants in meetings). The method records and tracks large deviations between the vectors as abnormalities. As an example, an abnormality indicated by the vector differences may arise because a participant who generally participates every time—as indicated by baseline vector values for participation—is not speaking much today; while at the same time few others are speaking more than usual. This combination might indicate that few others are trying to subjugate this user despite the user's lack of normal participation.

The method analyzes interaction trends between pairs of participants according to the ongoing determination of dynamics between pairs of participants, as well as according to the personality traits associated with each participant of the pair. In an embodiment, the method utilizes a second machine learning model to identify trends and patterns between pairs of participants. In an embodiment, the method utilizes a machine learning model including consideration of behaviors according to a personality trait model such as the Big 5 Personality trait model, to associated participants, interaction behavior and personality traits with the trends.

As an example, the method identifies interaction trends according to ongoing deviations between the vectors according to tone of the speaker's voice, percentage of each member's participation, participant's aggression levels etc. through facial analysis, and all other visual recognition based, audio/tone based, speech aggression based signals which can be acquired etc.

The method evaluates the trend data to detect bias between participants during the ongoing interactions. In an embodiment, the method analyzes facial expressions, voice tone changes, and discontinuity of sentences, for participants who have been overridden or otherwise interrupted—as indicated by analysis of the flow of the discussion. Data may be gathered in accordance with facial recognition and face detection software using the information provided by each participant. The method then extracts facial expressions from the detected and recognized facial data. In an embodiment, the method uses natural language processing to analyze the voice data and to identify incomplete sentence structures associated with being interrupted during speaking. In this embodiment, the method may further capture and analyze the facial expressions of other participants in the group interaction as, and after, the interruption occurs.

In an embodiment, the method determines interaction levels, including interaction fairness—how well each participant's contribution matches their desired level of contribution, and the presence of any interaction bias between each participant and any of the other participants. In this embodiment, the method analyzes the eye contact between individuals to detect bias between pairs of individuals. In this embodiment, a machine learning model, such as WATSON OPENSCALE, from IBM, Armonk, N.Y., evaluates video data of live or previous interactions on a frame by frame basis. The machine learning model starts from the baselines and model of the participants stored in the dictionary. The method adds the timestamped frame by frame analysis of the machine learning model to the dictionary entries and a dictionary buffer.

(Note: the terms “IBM”, “WATSON”, and “OPENSCALE”, may be subject to trademark rights in various jurisdictions throughout the world and are used here only in reference to the products or services properly denominated by the marks to the extent that such trademark rights may exist.)

In an embodiment, the method uses a personality trait-based perturbation approach to provide explainable model results regarding the presence or absence of bias in interactions and the underlying basis for such determinations. In this embodiment, the method maintains and updates a baseline behavior vector for each participant and tracks a real-time behavior vector for each participant. In an embodiment, the method tracks the difference between the two vectors against difference thresholds and identifies differences exceeding the threshold as abnormal or irregular participation behaviors. In an embodiment, the baseline vector includes ranges of values rather than a single value, real-time vector values outside the ranges of the baseline vector are identifies as abnormal or irregular behavior. In an embodiment, the identification of abnormal or irregular behaviors, as described above, leads to the generation of suggested actions to remediate the irregularities.

In an embodiment, the method uses user defined thresholds for abnormal levels of behavior differences. In an embodiment, the method analyzes interaction data to determine behavior difference levels associated with triggering positive and negative responses from other group members and adjusts the behavior thresholds accordingly. Positive and negative interaction responses associated with normal or baseline participant behavior do not trigger changes to thresholds.

As an example, the machine learning analysis provides Speaker S with Tone T and Utterances U at Frame F with Time T=T1 from a plurality of speakers and tonal variations i.e., S=S1, from S={S1, S2 . . . Sn} @ Frame F={F1, F2 . . . Fn}@ Time instants T={T1, . . . Tn}

The difference in speaker times and duration T_delta=T1=T′ is captured for the given Speaker with Sentiment analysis on the tone in the varying levels of {Soft, medium, Harsh} as example tones set based on the keywords and frequency f′.

The machine learning model ingests the data pertaining to the frequency variations and time deltas in order to derive LIME (local interpretable model-agnostic explanations) and Contrastive explainable insights and generate points on a scale of 1-5 with output of average sentiment, speaking duration and tone of the user with key phrases which are trained using Paragraphs as baseline for existing users.

Based upon the frame by frame analysis, the method generates detected bias interactions as an output, such as a rating of the bias on the scale of 1-5, the participants associated with the bias, the timestamps of the data indicating the bias, and a fairness score for each participant in the overall interaction.

In an embodiment, the method also considers the relative positioning of each participant within the group, sitting versus standing, etc., and the arrangement of the participants relative to each other, as well as the geographical locations of remote participants for completely or partially “virtual” meetings. In this embodiment, the method also appends such data regarding participants to the baseline and real-time feature vectors for the participants.

In an embodiment, method provides outputs relating to bias and fairness levels for each participant, to a meeting moderator. The method provides an indication as to each participants behavior relative to their baseline behavior. Indication such as participant P1 is speaking more than usual, or less than usual. Participant P2 is speaking louder than usual and with more aggression than usual, etc. The method further generates and provides suggested actions to the moderator, or other group participants. The suggested actions enable a shift in the overall group dynamics, reduce the negative effects of any bias, and increase the overall fairness of the group's interactions. In this embodiment, the method provides a graphical indication of overall fairness, such as a fairness meter indicating that interactions are fair, moderately fair or poor. The method may generate a suggested action such as “interrupt the interruption” using a phrase such as “hang on a sec— I want to make sure we capture P1's point before moving on”, suggesting a change in the group scribe—making a dominating or interrupting participant the scribe to occupy a portion of their attention, etc.

As an example, the deviation between the baseline vector and the real-time vector for any user, and whether the deviation is positive or negative from the baseline, is presented to the moderator. The moderator can see whether the user is being subjugated by others in the meeting or that the user is instead dominating others more than usual. This analysis can be provided to the moderator which can take some remedial action in the form of moderation or feedback to better regulate the discussion. The method detects the deviations from usual, for each user, and then presents the deviations to the moderator. The moderator can then choose to act to reduce the deviations.

In an embodiment, the method includes links to a machine learning based moderator and provides generated suggestions to alter group dynamics to the machine based moderator. In this embodiment, the machine learning based moderator then interjects the suggested actions into the current group interactions to alter the dynamics. In this embodiment, the method provides the moderator with indications of the current status of each participant relative to that participant's baseline behavior. The method provides an indication of participation less than normal, baseline normal, and exceeding normal levels for each member of the group.

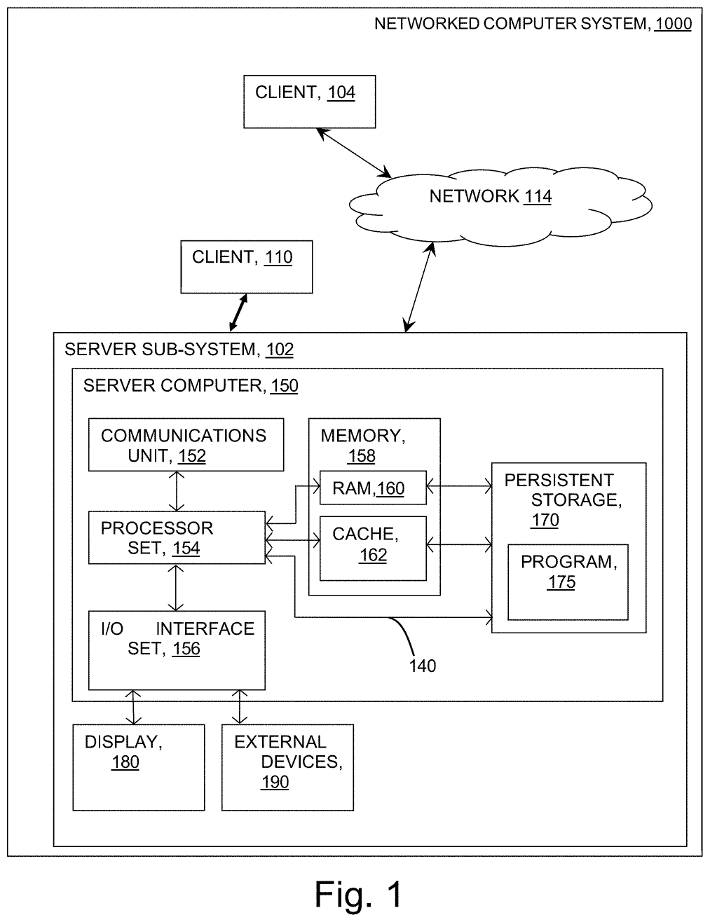

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise group dynamics analysis program (not shown) together with sufficient computing resource (processor, memory, network communications hardware) to execute the program. As shown in FIG. 1, server sub-system 102 comprises a server computer 150. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment can be made.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158.

Program instructions and data used to practice embodiments of the present invention, e.g., the group dynamics analysis program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110. In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., group dynamics analysis program 175 on server computer 150, can be stored on such portable computer readable storage media and can be loaded onto persistent storage 170 via I/O interface(s) 156. I/O interface(s) 156 also connect to a display 180.

Display 180 provides a mechanism to display data to a user and may be, for example, a computer monitor. Display 180 can also function as a touch screen, such as a display of a tablet computer.

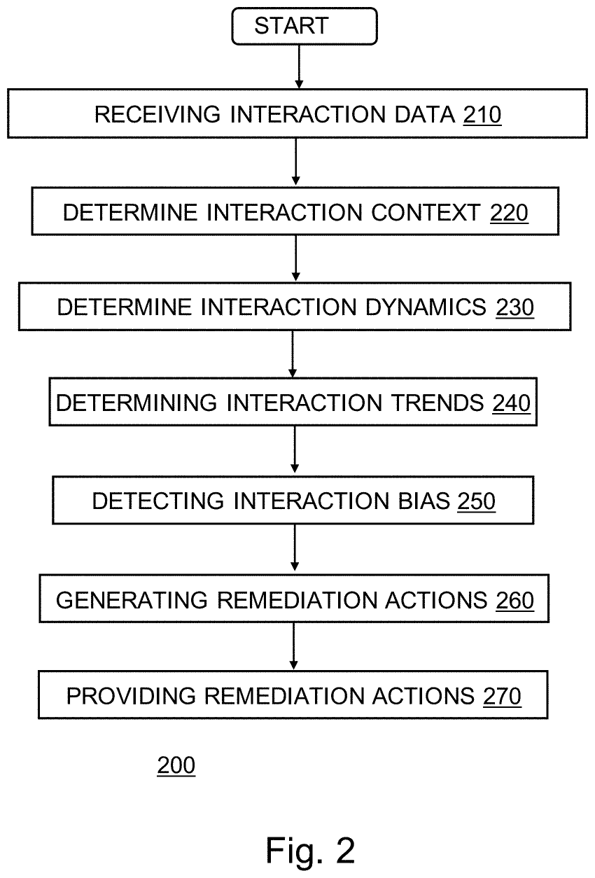

FIG. 2 provides a flowchart 200, illustrating exemplary activities associated with the practice of the disclosure. After program start, at block 210, the method receives data relating to the interaction of a plurality of participants. The method has previously received identifying audio and video data for each participant, with the consent of each participant to the collection and use of such data. The method uses the provided audio and video data to analyze the interaction data.

At block 220, the method determines an interaction context according to the identification of participants and the patterns of speech interactions between the members of the group. The method identifies participants by using face detection and facial recognition using the provided video data, and further uses the provided audio data to determine who is speaking and for how long.

At block 230, the method determines the interaction dynamics of group participants, according to the patterns of interactions between participants, the responses of participants, and the tone of speech used by participants. The method may analyze the facial expressions of both speaking and non-speaking participants. As part of determining the dynamics in view of the context, the method uses baseline behaviors for each participant.

The method determines participant baselines according to observed interactions, including interactions from previous meetings. The method determines baseline, or normal, group behavior for participants, and determines current interaction dynamics according to adherence to, or deviations from, baseline behavior for each participant. The method also analyzes the tone and facial expression data described above, as well as sentence structures, detecting sentence fragments associated with being interrupted, or multiple speaker at one time. Multiple speakers indicating a first speaker being overridden by a second speaker. The method also considers the relative amounts of time consumed by each speaker of the group. In an embodiment, the method applies a reinforcement learning model to analyze the interactions and determine the interaction dynamics.

At block 240, the method identifies trends in the interaction dynamics using a machine learning model such as perturbed personality trait machine learning model, analyzing the interaction dynamics exchanges. The method identifies trends indicative of bias between participants over the course of the timeline of the interactions at block 250.

At block 260, the method generates suggested actions for either a human or machine-based moderator to disrupt and alter the current dynamics, reducing the effect of bias upon the overall group interaction. Actions such as changing the roles to provide a new group scribe—thereby occupying more of a chronic interrupter's time, or suggesting comments to ensure that all participants join the discussion and that the input of everyone is captured and appropriately considered.

At block 270, the method provides the suggested actions, enabling alterations to remediate the current dynamic to lessen the impact of participant bias upon the groups functioning and interactions. The suggested actions may be provided using a video display or an audio output device such as a speaker, headphones, or ear buds. The moderator may then choose to act upon the suggestion to alter the current course of the group's interactions. For a machine-based moderator, the method may provide the suggested action and the system may use an audio or video output device to provide the suggestion to the members of the group.

Local computing environments may lack sufficient resources for the real-time processing of data associated with the disclosed embodiments. Users may connect to edge cloud and cloud resources to gain access to the large-scale computing resources necessary to carry out the steps of disclosed embodiments in time frames rendering the results useful. Post-interaction suggestions for the reduction of bias by altering group dynamics lack the impact of such suggestions provided during the real-time interactions between group members.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

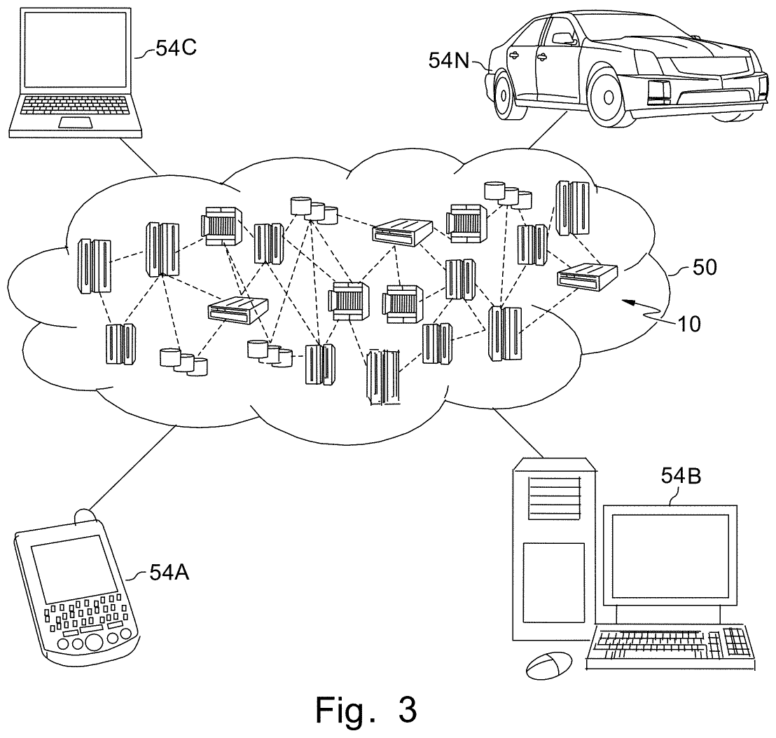

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

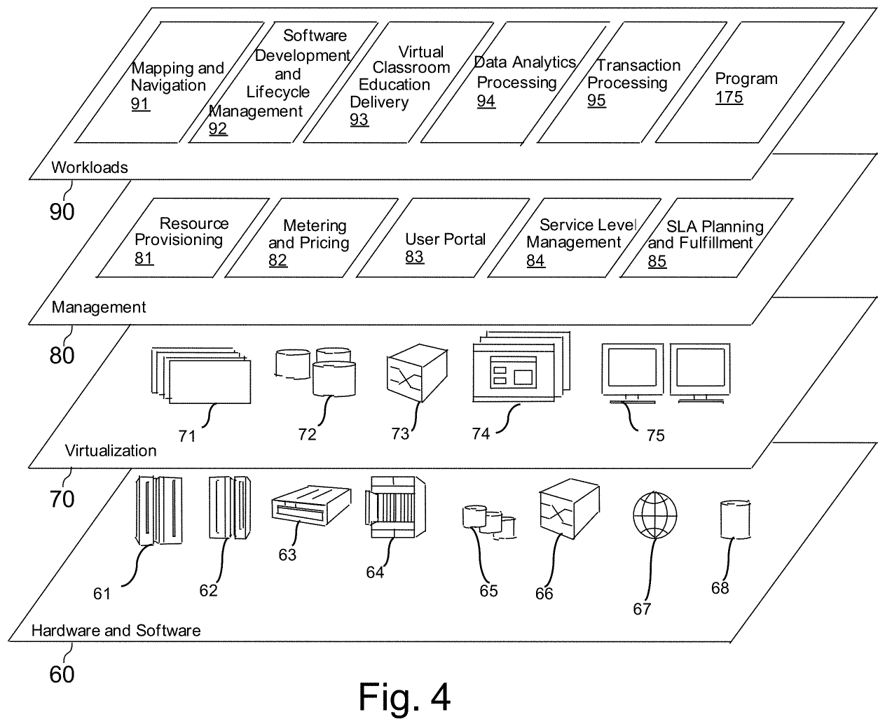

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and group dynamics analysis program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for analyzing and enabling shifts in group dynamics, the method comprising:
receiving, by one or more computer processors, data regarding interactions of a plurality of participants;
determining, by the one or more computer processors, an interaction context according to the data;
determining, by the one or more computer processors, interaction dynamics according to the interaction context using a first machine learning model;
determining, by the one or more computer processors, an interaction trend between a first participant and a second participant, according to the interaction dynamics, using a second machine learning model;
detecting, by the one or more computer processors, a bias between the first participant and the second participant according to the interaction trend;
generating, by the one or more computer processors, a remediation action to shift the interaction dynamics; and
providing, by the one or more computer processors, the remediation action to at least one participant.

2. The computer implemented method according to claim 1, further comprising:
receiving, by the one or more computer processors, data regarding at least one of the plurality of participants;
determining, by the one or more computer processors, a baseline personality trait, for the at least one participant;
storing, by the one or more computer processors, the baseline personality trait in a repository; and
adjusting, by the one or more computer processors, the stored baseline personality trait according to interaction data associated with the at least one participant.

3. The computer implemented method according to claim 1, wherein the first machine learning model comprises a reinforcement learning model.

4. The computer implemented method according to claim 1, wherein the second machine learning model comprises a big five personality model.

5. The computer implemented method according to claim 1, further comprising determining, by the one or more computer processors, which participant is speaking at each moment and how much each participant speaks during the interaction.

6. The computer implemented method according to claim 1, wherein detecting a bias between the first participant and the second participant according to the interaction trend comprises detecting a bias according to eye contact of a speaker.

7. The computer implemented method according to claim 1, wherein detecting a bias between the first participant and the second participant according to the interaction trend comprises detecting bias according to cues associated with an overridden participant.

8. A computer program product for analyzing and enabling shifts in group dynamics, the computer program product comprising one or more computer readable storage devices and collectively stored program instructions on the one or more computer readable storage devices, the stored program instructions comprising:
program instructions to receive data regarding interactions of a plurality of participants;
program instructions to determine an interaction context according to the data;
program instructions to determine interaction dynamics according to the interaction context using a first machine learning model;
program instructions to determine an interaction trend between a first participant and a second participant, according to the interaction dynamics, using a second machine learning model;
program instructions to detect a bias between the first participant and the second participant according to the interaction trend;
program instructions to generate a remediation action to shift the interaction dynamics; and
program instructions to provide the remediation action to at least one participant.

9. The computer program product according to claim 8, the stored program instructions further comprising:
program instructions to receive data regarding at least one of the plurality of participants;
program instructions to determine a baseline personality trait, for the at least one participant;
program instructions to store the baseline personality trait in a repository; and
program instructions to adjust the stored baseline personality trait according to interaction data associated with the at least one participant.

10. The computer program product according to claim 8, wherein the first machine learning model comprises a reinforcement learning model.

11. The computer program product according to claim 8, wherein the second machine learning model comprises a big five personality model.

12. The computer program product according to claim 8, the stored program instructions further comprising program instructions to determine which participant is speaking at each moment and how much each participant speaks during the interaction.

13. The computer program product according to claim 8, wherein detecting a bias between the first participant and the second participant according to the interaction trend comprises detecting a bias according to eye contact of a speaker.

14. The computer program product according to claim 8, wherein detecting a bias between the first participant and the second participant according to the interaction trend comprises detecting bias according to cues associated with an overridden participant.

15. A computer system for analyzing and enabling shifts in group dynamics, the computer system comprising:
one or more computer processors;
one or more computer readable storage devices; and
stored program instructions on the one or more computer readable storage devices for execution by the one or more computer processors, the stored program instructions comprising:
program instructions to receive data regarding interactions of a plurality of participants;
program instructions to determine an interaction context according to the data;
program instructions to determine interaction dynamics according to the interaction context using a first machine learning model;
program instructions to determine an interaction trend between a first participant and a second participant, according to the interaction dynamics, using a second machine learning model;
program instructions to detect a bias between the first participant and the second participant according to the interaction trend;
program instructions to generate a remediation action to shift the interaction dynamics; and
program instructions to provide the remediation action to at least one participant.

16. The computer system according to claim 15, the stored program instructions further comprising:
program instructions to receive data regarding at least one of the plurality of participants;
program instructions to determine a baseline personality trait, for the at least one participant;
program instructions to store the baseline personality trait in a repository; and
program instructions to adjust the stored baseline personality trait according to interaction data associated with the at least one participant.

17. The computer system according to claim 15, wherein the first machine learning model comprises a reinforcement learning model.

18. The computer system according to claim 15, wherein the second machine learning model comprises a big five personality model.

19. The computer system according to claim 15, the stored program instructions further comprising program instructions to determine which participant is speaking at each moment and how much each participant speaks during the interaction.

20. The computer system according to claim 15, wherein detecting a bias between the first participant and the second participant according to the interaction trend comprises detecting a bias according to eye contact of a speaker.
